(19) United States
(12) Patent Application Publication
(10) Pub. No.: US 2024/0015560 A1
(43) Pub. Date: Jan. 11, 2024

(54) MANAGEMENT SERVER, VEHICLE NETWORK SYSTEM, AND COMMUNICATION TRAFFIC COLLECTION METHOD

(71) Applicant: DENSO CORPORATION, Kariya-city (JP)

(72) Inventor: Koichiro TAKEUCHI, Kariya-city (JP)

(21) Appl. No.: 18/347,609

(22) Filed: Jul. 6, 2023

(30) Foreign Application Priority Data
Jul. 8, 2022 (JP) 2022-110647

(51) Int. Cl. H04W 28/02; G07C 5/00

(52) U.S. Cl. CPC H04W 28/0231; G07C 5/008

(57) ABSTRACT

By a management server, a vehicle network system, or a communication traffic collection method, multiple in-vehicle devices, which are respectively mounted on multiple different vehicles, are wirelessly communicated, each of the multiple in-vehicle devices executes multiple application programs, and each of the multiple application programs has application identification data for identifying each of the multiple application programs, a communication traffic according to execution of each of the plurality of application programs is acquired, the communication traffic is totaled, and an application communication traffic is calculated.

### CROSS REFERENCE TO RELATED APPLICATION

The present application claims the benefit of priority from Japanese Patent Application No. 2022-110647 filed on Jul. 8, 2022. The entire disclosure of the above application is incorporated herein by reference.

### TECHNICAL FIELD

The present disclosure relates to communications in a vehicle network system.

### BACKGROUND

An in-vehicle information utilization network system of a comparative example includes an in-vehicle network system, an inspection system, an in-vehicle information communication device, a mobile computer, a server device, and a client device. The in-vehicle information communication device receives in-vehicle data from the in-vehicle network system and the inspection system, and transmits the received in-vehicle data to the mobile computer by short-range communication. The mobile computer transmits in-vehicle data to the server device by long-range communication.

### SUMMARY

By a management server, a vehicle network system, or a communication traffic collection method, multiple in-vehicle devices, which are respectively mounted on multiple different vehicles, are wirelessly communicated, each of the multiple in-vehicle devices executes multiple application programs, and each of the multiple application programs has application identification data for identifying each of the multiple application programs, a communication traffic according to execution of each of the plurality of application programs is acquired, the communication traffic is totaled, and an application communication traffic is calculated.

### BRIEF DESCRIPTION OF DRAWINGS

FIG. 1 is a block diagram showing a configuration of a vehicle network system according to an embodiment.

FIG. 2 is a block diagram showing the hardware configuration of an in-vehicle device according to the embodiment.

FIG. 3 is a block diagram showing the hardware configuration of a management server according to the embodiment.

FIG. 4 is a flowchart showing a communication traffic measurement process executed by the in-vehicle device according to the embodiment.

FIG. 5 is a flowchart showing a communication restriction process executed by the in-vehicle device according to the embodiment.

FIG. 6 is a flowchart showing a communication restriction release process executed by the in-vehicle device according to the embodiment.

FIG. 7 is a flowchart showing a communication traffic measurement process executed by a management server according to the embodiment.

FIG. 8 is a flowchart showing a communication restriction request process executed by the management server according to the embodiment.

FIG. 9 is a flowchart showing a communication restriction release request process executed by the management server according to the embodiment.

### DETAILED DESCRIPTION

In the in-vehicle information utilization network system described above, all in-vehicle data acquired on the network is transmitted to the server device. Therefore, even unnecessary in-vehicle data is transmitted to the server device, so that the communication traffic increases. In order to reduce the increase in communication traffic due to such unnecessary data transmission, it is desired to grasp a communication status on the network.

One example of the present disclosure provides a technology capable of grasping a communication status on a vehicle network system.

According to one example embodiment, a management server includes a server communication unit and a communication traffic management unit. The server communication unit wirelessly communicates with multiple in-vehicle devices respectively mounted on different vehicles. Each of the multiple in-vehicle devices executes multiple application programs. Each of the multiple application programs has application identification data that identifies each of the multiple application programs. The communication traffic management unit acquires a communication traffic according to execution of each of the multiple application programs from each of the multiple in-vehicle devices, totals the communication traffic for each application identification data, and calculates an application communication traffic.

The management server described above acquires communication traffic from each of the multiple in-vehicle devices, and aggregates the communication traffic for each application identification data. Accordingly, the management server can grasp the communication status between the management server and the multiple in-vehicle devices. As a result, the management server can take means according to the communication status.

According to another example embodiment, a vehicle network system includes multiple in-vehicle devices respectively mounted on multiple different vehicles and a management server. Each of the in-vehicle devices includes an in-vehicle communication unit, an application execution unit, and a communication traffic measurement unit. The in-vehicle communication unit wirelessly communicates with the management server. The application execution unit installs and executes multiple application programs. Each of the multiple application programs has application identification data that identifies each of the multiple application programs. The communication traffic measurement unit measures a communication traffic according to execution of each of the multiple application programs by the application execution unit for each application identification data, and transmits, to the management server via the in-vehicle communication unit, communication information in which each measured communication traffic is associated with the application identification data. The management server includes a server communication unit and a communication traffic management unit. The server communication unit wirelessly communicates with multiple in-vehicle devices. The communication traffic management unit acquires communication information from each of the multiple in-vehicle devices, totals the communication traffic for each application identification data, and calculates an application communication traffic.

The vehicle network system has the similar effects to the management server.

Further, according to another example embodiment, a communication traffic collection method includes: wirelessly communicating with multiple in-vehicle devices that are respectively mounted on multiple different vehicles, wherein each of the multiple in-vehicle devices is configured to execute multiple application programs, and each of the multiple application programs has application identification data for identifying each of the multiple application programs; acquiring a communication traffic according to execution of each of the multiple application programs from each of the multiple in-vehicle devices; totaling the communication traffic for each application identification data; and calculating an application communication traffic.

### (1. Configuration)

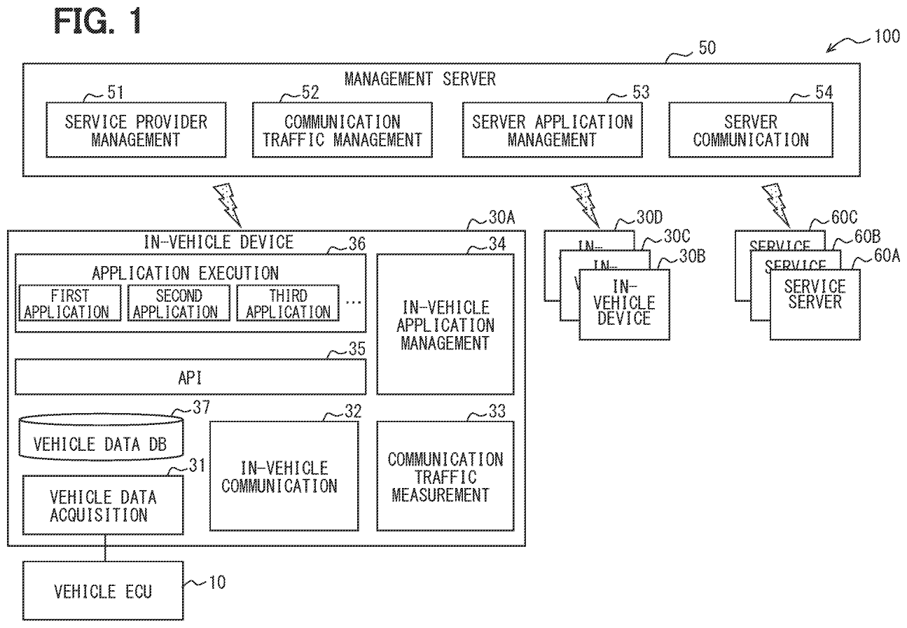

A schematic configuration of a vehicle network system 100 according to the present embodiment will be described with reference to FIG. 1. The vehicle network system 100 includes a management server 50, multiple in-vehicle devices 30A, 30B, and 30D, and multiple service servers 60A, 60B, and 60C. The number of in-vehicle devices included in the vehicle network system 100 is not limited to four, and may be two, three, five or more. Further, the number of service servers provided in the vehicle network system 100 is not limited to three, and may be two or four or more. Hereinafter, the in-vehicle devices 30A, 30B, 30C, and 30D are collectively referred to as an in-vehicle device 30, and the service servers 60A, 60B, and 60C are collectively referred to as a service server 60.

Each of the in-vehicle devices 30 is mounted on a different vehicle, and collects vehicle data. Further, each of the in-vehicle devices 30 executes one or more application programs provided by the service server 60 and processes the vehicle data to generate processed data. The management server 50 is installed outside the vehicle, and manages application programs provided by each of the service servers 60.

Each service server 60 is used by each of multiple service business workers (specifically, service providers). Each service provider may install and utilize the service server 60 by itself, or may utilize the service server 60 installed by another person (for example, an operator of the management server 50). Each of the service servers 60 acquires the vehicle data or the processed data via the management server 50 and provides a service to a service user using the vehicle data or the processed data. The service user is a vehicle user such as an owner or an operation manager, and the service is fleet services, congestion prediction services, or the like.

The service provider develops an application program according to the service provided by the service server 60. The service provider registers the developed application program in the management server 50. The service user makes a contract with one of the service providers, and downloads, from the management server 50, an application program developed by the contracted service provider. The management server 50 manages the communication traffic of data related to an in-vehicle device application for each application.

### (1-1. Configuration of In-Vehicle Device)

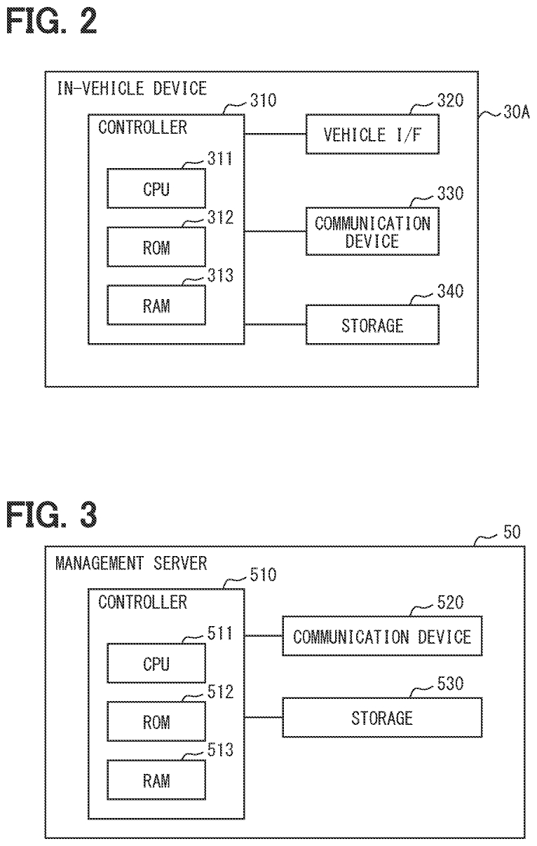

As shown in FIG. 2, the in-vehicle device 30 includes a controller 310, a vehicle interface (hereinafter referred to as vehicle I/F) 320, a communication device 330 and a storage 340.

The controller 310 includes a CPU 311, a ROM 312, and a RAM 313. Various functions of the controller 310 are implemented by the CPU 311 executing a program stored in a non-transitory tangible storage medium. In the present embodiment, the ROM 312 corresponds to a non-transitory tangible storage medium storing programs. A method corresponding to the program is performed by executing the program.

The vehicle I/F 320 is connected to one or more vehicle electronic control units (hereinafter referred to as vehicle ECUs) 10 via an in-vehicle network or the like of the vehicle, and acquires various vehicle data from each vehicle ECU 10. Each vehicle ECU 10 controls various devices, such as a brake, a steering wheel, a camera, and a radar. The in-vehicle network may include CAN and Ethernet. The CAN is an abbreviation for Controller Area Network. The CAN is a registered trademark. The Ethernet is a registered trademark.

The communication device 330 performs data communication with the management server 50 via a wide area communication network by wireless communication.

The storage 340 includes a vehicle database (hereinafter referred to as vehicle data DB) 37, and stores vehicle data and the like acquired via the vehicle I/F 320.

As shown in FIG. 1, the in-vehicle device 30 has functions of a vehicle data acquisition unit 31, an in-vehicle communication unit 32, a communication traffic measurement unit 33, an in-vehicle application management unit 34, an API 35 and an application execution unit 36.

The vehicle data acquisition unit 31 repeatedly acquires vehicle data related to various devices from the vehicle ECU 10 at a predetermined acquisition cycle. The vehicle data includes operation amounts of various devices, detection data detected by various devices, and the like. For example, the vehicle data includes, for example, an on-off state of brake, a vehicle speed, or a steering wheel angle. The vehicle data may include not only raw data but also normalized or standardized data so as to eliminate variations among vehicle types. The vehicle data acquisition unit 31 stores the acquired vehicle data in the vehicle data DB 37 in association with the type of the vehicle data and the acquisition time.

The in-vehicle communication unit 32 controls the communication device 330 to wirelessly communicate with the management server 50.

The API 35 is a standard interface for application execution unit 36 to access the vehicle data DB 37.

The application execution unit 36 accesses the vehicle data DB 37 via the API 35 and executes application programs using the vehicle data. The application programs include a first application, a second application, a third application, and the like. The application execution unit 36 downloads and installs each of the first application, the second application, and the third application from the management server 50.

The first application is an application program developed by a provider of the service server 60A and provided via the management server 50. By executing the first application, the application execution unit 36 generates, from the vehicle data, processed data necessary for the service server 60A to provide the first service. The second application is an application program developed by a provider of the service server 60B and provided via the management server 50. By executing the second application, the application execution unit 36 generates, from the vehicle data, processed data necessary for the service server 60B to provide the second service. The third application is an application program developed by a provider of the service server 60C and provided via the management server 50. By executing the third application, the application execution unit 36 generates, from the vehicle data, processed data necessary for the service server 60C to provide the third service.

The application execution unit 36 executes each of the first application, the second application, and the third application as containers. The application execution unit 36 may install and execute only one or two application programs, or may install and execute four or more application programs.

The in-vehicle application management unit 34 associates and manages the application IDs and container IDs of the application programs installed in the in-vehicle device 30. The application ID is an ID assigned to each application program and is a common ID in the vehicle network system 100. That is, when the first application installed on the in-vehicle device 30A is the same as the first application installed on the in-vehicle device 30B, the two application programs have the same application ID. A container ID is a temporary local ID attached to each in-vehicle device 30. In the present embodiment, the application ID corresponds to the application identification data of the present disclosure, but the application identification data is not limited to the application ID, and may be any data that can identify the application program.

The communication traffic measurement unit 33 measures the communication traffic of the in-vehicle communication unit 32 with the management server 50 for each container ID. When the application execution unit 36 executes the application program, data communication is performed between the in-vehicle device and the management server 50. The traffic of communication between the in-vehicle device 30 and the management server 50 differs depending on the type of application program. Therefore, the communication traffic measurement unit 33 measures the communication traffic due to execution of the application program by the application execution unit 36 for each container ID. Further, the communication traffic measurement unit 33 acquires an application ID corresponding to the container ID from the in-vehicle application management unit 34, and associates the communication traffic for each container ID with the application ID. Then, the communication traffic measurement unit 33 transmits the communication information to the management server 50 via the in-vehicle communication unit 32 at a predetermined transmission cycle or just before the in-vehicle device 30 stops. The communication information corresponds to information in which the communication traffic within the transmission cycle is associated with the application ID.

### (1-2. Management Server Configuration)

As shown in FIG. 3, the management server 50 includes a controller 510, a communication device 520, and a storage 530.

The controller 510 includes a CPU 511, a ROM 512, and a RAM 513. Various functions of the controller 510 are implemented by the CPU 511 executing a program stored in a non-transitory tangible storage medium. In this example, the ROM 512 corresponds to a non-transitory tangible storage medium storing programs. A method corresponding to the program is performed by executing the program.

The communication device 520 wirelessly connects with each in-vehicle device 30 and the service server 60 via the wide area communication network to perform data communication.

The storage 530 stores vehicle data and the like provided from the in-vehicle device 30.

As shown in FIG. 1, the management server 50 has functions of a service provider management unit 51, a communication traffic management unit 52, a server application management unit 53, and a server communication unit 54.

The service provider management unit 51 manages information (that is, service provider information) of the service providers that provide the service servers 60.

The server application management unit 53 manages application programs registered by each of the service servers 60. Specifically, the server application management unit 53 manages the application ID of each application program in association with the service provider (for example, identification data of the service provider) that provided the application program.

The server communication unit 54 controls the communication device 520 to wirelessly communicate with each of the in-vehicle devices 30 and each of the service servers 60.

The communication traffic management unit 52 collects and stores communication information from each of the in-vehicle devices 30 connected to the management server 50 at a predetermined cycle. The communication traffic management unit 52 totalizes the collected communication information for each application ID, and calculates the application communication traffic for each application ID. Further, the communication traffic management unit 52 acquires the service provider corresponding to the application ID from the server application management unit 53 and the service provider management unit 51, totals the application communication traffic for each service provider, and calculates the total communication traffic.

A single service provider may provide multiple application programs. Therefore, the communication traffic management unit 52 divides the multiple application programs registered in the server application management unit 53 into multiple groups. Each of the multiple groups is provided by a different service provider. Then, the communication traffic management unit 52 totals the application communication traffic corresponding to the application IDs included in each group, and calculates the total communication traffic for each service provider.

### (2. Process)

### (2-1. Process Executed by In-Vehicle Device)

### (2-1-1. Communication Traffic Measurement Process)

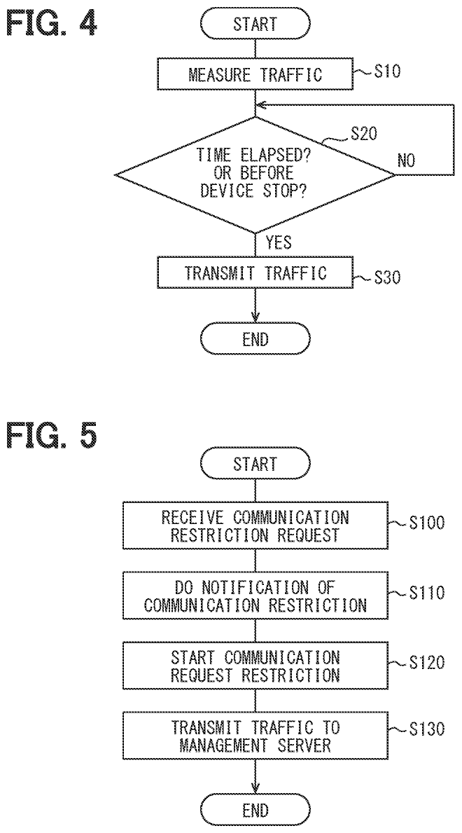

Next, with reference to the flowchart of FIG. 4, a communication traffic measurement process executed by the in-vehicle device 30 will be described. The in-vehicle device 30 repeatedly executes the communication traffic measurement process at a predetermined process cycle.

In S10, the communication traffic measurement unit 33 measures the communication traffic with the management server 50 from the time when the communication traffic was measured last time to the current time, for each application ID. The in-vehicle device 30 adds an application communication traffic each time it communicates with the management server 50.

Next, in S20, the communication traffic measurement unit 33 determines whether a predetermined time has elapsed since the communication traffic was transmitted to the management server 50 last time, or whether the in-vehicle device is about to stop. The in-vehicle device 30 stops when the vehicle on which the in-vehicle device 30 is mounted stops. Therefore, the in-vehicle device 30 determines whether a predetermined time has elapsed since the previous transmission or whether the vehicle is about to stop. When it is determined that the predetermined time has elapsed since the previous transmission or that the in-vehicle device 30 is about to stop, the process proceeds to S30. When it is determined that the predetermined time has not elapsed since the previous transmission and also that the in-vehicle device 30 is not about to stop, the process of S20 is repeatedly executed.

Next, in S30, the in-vehicle communication unit 32 associates the communication traffic for each application ID with the application ID and transmits it to the management server 50.

### (2-1-2. Communication Restriction Process)

Next, with reference to the flowchart of FIG. 5, a communication restriction process executed by the in-vehicle device 30 will be described. The management server 50 transmits a communication restriction request to the in-vehicle device 30 installed with the application program provided by an excessive communication traffic service provider. The excessive communication traffic service provider is a service provider whose total communication traffic exceeds a set upper limit value. Here, a process when the in-vehicle device 30 receives a communication restriction request from the management server 50 will be described.

In S100, the in-vehicle communication unit 32 receives the communication restriction request from the management server 50. The communication restriction request is a communication restriction request for the application ID of the application program provided by the excessive communication traffic service provider. The communication restriction includes limiting the communication traffic to a predetermined value or less and stopping communication.

In S110, the in-vehicle communication unit 32 notifies the application execution unit 36 of the communication restriction. Upon receiving the notification, the application execution unit 36 stops executing the application program (hereinafter referred to as a communication restriction application) corresponding to the application ID specified by the communication restriction, and puts the application program in a standby state.

In S120, the in-vehicle communication unit 32 starts restricting the communication request from the application execution unit 36. That is, upon receiving a communication restriction request from the management server 50, the in-vehicle communication unit 32 restricts communication even when receiving a communication request associated with execution of the communication restriction application from the application execution unit 36.

In S130, the communication traffic measurement unit 33 measures the communication traffic due to the execution of the communication restriction application from when the in-vehicle communication unit 32 receives the communication restriction request to when the communication restriction starts. Then, the in-vehicle communication unit 32 transmits the measured communication traffic to the management server 50.

### (2-1-3. Communication Restriction Release Process)

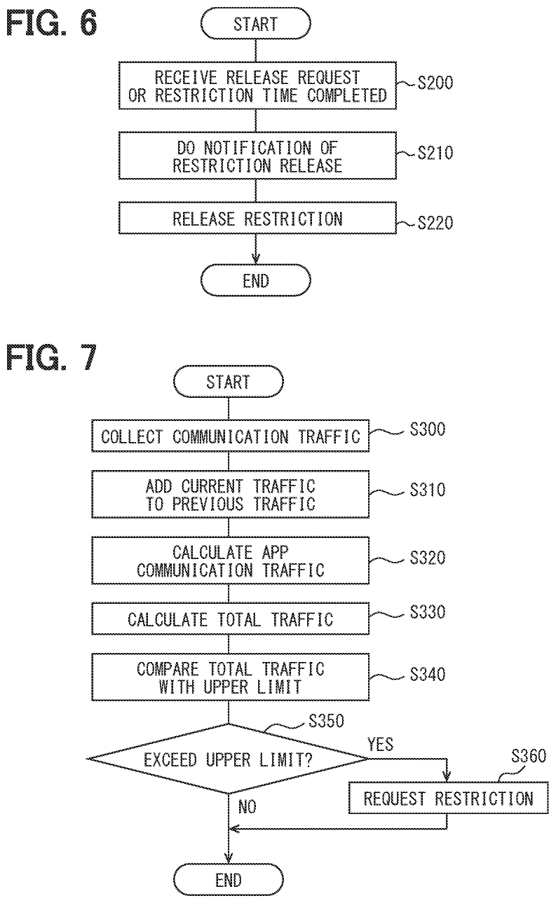

Next, with reference to the flowchart of FIG. 6, a communication restriction release process executed by the in-vehicle device 30 will be described.

In S200, the in-vehicle communication unit 32 receives a communication restriction release request from the management server 50. Alternatively, the period of communication restriction is completed. For example, when the set upper limit of communication traffic is set for each month, the period of communication restriction will be from a point when the communication traffic exceeds the set upper limit value until the end of the month. After the end of the month, the communication restriction period ends.

Next, in S210, the in-vehicle communication unit 32 notifies the application execution unit 36 of release of the communication restriction. The application execution unit 36 receives the notification and starts executing the communication restriction application.

Next, in S220, the in-vehicle communication unit 32 releases the restriction on the communication request from the application execution unit 36. That is, when receiving the communication request from the application execution unit 36, the in-vehicle communication unit 32 communicates with the management server 50 without restricting communication.

### (2-2. Process Executed by Management Server)

### (2-2-1. Communication Traffic Measurement Process)

Next, with reference to the flowchart of FIG. 7, a communication traffic measurement process executed by the management server 50 will be described. The management server 50 repeatedly executes the communication traffic measurement process at a predetermined process cycle.

In S300, the server communication unit 54 collects communication information indicating the communication traffic for each application ID from each in-vehicle device 30 connected to the management server 50.

Next, in S310, the communication volume management unit 52 adds the communication traffic acquired this time to the communication traffic acquired in the previous process cycle for each in-vehicle device 30 and each application ID. The communication traffic acquired this time may be also referred to as a current traffic.

Next, in S320, the communication traffic management unit 52 aggregates the communication traffic calculated in S310 for each application ID among the in-vehicle devices 30 connected to the management server 50, and calculates the application communication traffic.

Next, in S330, for each service provider, the application communication traffic corresponding to the application ID provided by the service provider is totaled to calculate the total communication traffic.

Next, in S340, the total communication traffic calculated in S330 and the set upper limit value are compared for each service provider. The set upper limit value is determined for each service provider according to the contract between the service provider and the operator of the management server 50.

In S350, it is determined whether the total communication traffic exceeds the set upper limit value for each service provider. When any of the total communication traffic exceeds the set upper limit value, the process proceeds to S360. When the total communication traffic is equal to or less than the set upper limit value, the process ends.

In S360, the communication restriction request is provided to the excessive communication traffic service provider.

### (2-2-2. Communication Restriction Request Process)

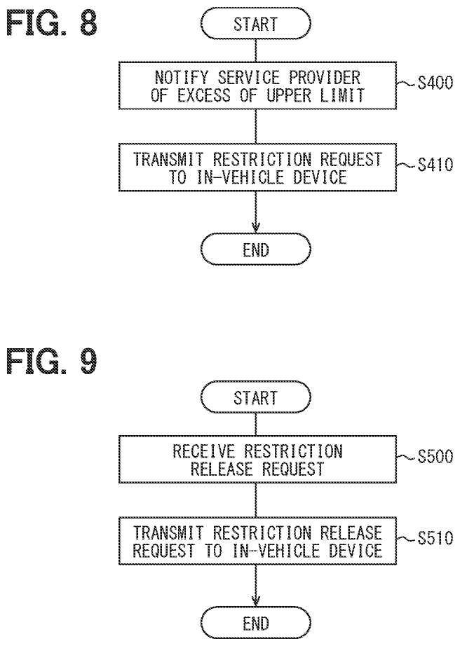

Next, with reference to the flowchart of FIG. 8, a communication restriction request process executed by the management server 50 will be described.

In S400, the excessive communication traffic service provider determined in S360 is notified of the excess of the upper limit via the corresponding service server 60.

Next, in S410, the communication restriction request is transmitted to the in-vehicle device 30 in which an application program related to the excessive communication traffic service provider is installed.

### (2-2-3. Communication Restriction Release Request Process)

Next, with reference to the flowchart of FIG. 9, a communication restriction release request process executed by the management server 50 will be described.

In S500, a communication restriction release request is received via the corresponding service server 60 from the excessive communication traffic service provider. The excess communication traffic service provider requests the management server 50 to release the communication restriction when a condition for releasing the communication restriction is satisfied. The condition for releasing the communication restriction is, for example, payment of an additional charge. The set upper limit value increases according to the payment of the additional charge.

Next, in 510, the communication restriction release request is transmitted to the in-vehicle device in which an application program related to the excessive communication traffic service provider is installed.

### (3. Effects)

According to the present embodiment described in detail above, the following effects are obtained.
(1) The management server 50 acquires the communication traffic from each of the multiple in-vehicle devices 30, aggregates the communication traffic for each application ID, and calculates the application communication traffic. Accordingly, the management server 50 can grasp the communication status on the vehicle network system 100. As a result, the management server 50 can take means according to the communication status.
(2) The management server 50 totals the application communication traffic for each service provider to calculate the total communication traffic. Accordingly, the management server 50 can grasp the total communication traffic for each service provider.
(3) The excess of the communication traffic is notified to the excessive communication traffic service provider. Thereby, the service provider can take means such as restricting the communications and paying additional charges.
(4) The communication restriction is requested for the in-vehicle device 30 installed with the application program related to the excessive communication traffic service provider. Thereby, the in-vehicle device 30 can recognize and deal with the excess of the communication traffic.
(5) The in-vehicle communication unit 32 receives the request for communication restriction and notifies the application execution unit 36, whereby the application execution unit 36 can stop the execution of the application program and reduce the communication traffic.
(6) Even when the in-vehicle communication unit 32 receives a communication request from the application execution unit 36, it is possible to reduce the communication traffic by restricting the communication.

### Other Embodiments

Although the embodiment of the present disclosure has been described above, the present disclosure is not limited to the embodiment described above, and various modifications can be made to implement the present disclosure.
(a) In the above embodiment, the communication traffic measurement unit 33 measures the communication traffic, and generates communication information indicating the communication traffic associated with the application ID. The communication traffic measurement unit 33 may measure the communication traffic, acquire the transmission destination of communication, the type of communication, and add the acquired destination, the acquired type, and the acquired vehicle state to the communication information. The transmission destination of communication is a server provided by a service provider, a server provided by an operator of a management server, or the like. The type of communication is a cellular line, a Wi-Fi (registered trademark) line, or the like. The state of the vehicle is a traveling state, a parking state, or the like.

According to such a configuration, the transmission destination and the communication type can be used for setting the communication fee. Communication when the vehicle is parked is more likely to cause a battery to die than communication when the vehicle is traveling. Therefore, the vehicle state is used to set the communication fee, and the communication fee in the vehicle state, which is likely to cause the battery to die, is set higher than the communication fee in the vehicle state, which is not likely to cause the battery to die. Thereby, it is possible to reduce the communication in the vehicle state which is likely to cause the battery to die.
(b) The controllers 310 and 510 and methods thereof described in the present disclosure may be implemented by a dedicated computer provided by configuring a processor and a memory programmed to execute one or more functions embodied by a computer program. Alternatively, the controllers 310 and 510 and methods thereof described in the present disclosure may be implemented by a dedicated computer provided by configuring the processor with one or more dedicated hardware logic circuits. Alternatively, the controller 310 and 510 and methods thereof described in the present disclosure may be implemented by one or more dedicated computers configured with a combination of a processor and a memory programmed to execute one or more functions, and a processor configured with one or more hardware logic circuits. The computer program may be stored in a computer-readable non-transitory tangible storage medium as instructions to be executed by the computer. The methods of implementing the function of each part included in the controllers 310 and 510 do not necessarily include software, and all the functions may be implemented using one or more pieces of hardware.
(c) The multiple functions of one component in the above embodiments may be implemented by multiple components, or a function of one component may be implemented by multiple components. Further, multiple functions of multiple elements may be implemented by one element, or one function implemented by multiple elements may be implemented by one element. A part of the configuration of the above embodiment may be omitted as appropriate. At least a part of the configuration in one embodiment may be added to or substituted for the configuration of another embodiment.
(d) The present disclosure may be implemented by, in addition to the management server and the vehicle network system described above, various forms such as a program causing a computer to function as the in-vehicle device, a non-transitory tangible storage medium including a semiconductor memory storing the program, and a communication traffic collection method of the vehicle network.

Here, the process of the flowchart or the flowchart described in this application includes a plurality of sections (or steps), and each section is expressed as, for example, S11. Further, each section may be divided into several subsections, while several sections may be combined into one section. Furthermore, each section thus configured may be referred to as a device, module, or means.

1. A management server comprising:
a server communication unit that
is configured to wirelessly communicate with a plurality of in-vehicle devices that are respectively mounted on a plurality of different vehicles, wherein each of the plurality of in-vehicle devices is configured to execute a plurality of application programs, and each of the plurality of application programs has application identification data for identifying each of the plurality of application programs; and
a communication traffic management unit configured to
acquire a communication traffic according to execution of each of the plurality of application programs from each of the plurality of in-vehicle devices,
total the communication traffic for each application identification data, and
calculate an application communication traffic.

2. The management server according to claim 1, wherein
the server communication unit is configured to wirelessly communicate with a service server related to each of a plurality of service providers,
the plurality of application programs are divided into a plurality of groups,
each of the plurality of groups is provided by a different service provider among the plurality of service providers, and
the communication traffic management unit is configured to total a corresponding application communication traffic for each of the plurality of groups to calculate a total communication traffic for each of the plurality of groups.

3. The management server according to claim 2, wherein
the communication traffic management unit is configured to
determine whether the calculated total communication traffic exceeds a set upper limit value for each of the plurality of groups, and
notify a service server related to a corresponding service provider among the plurality of service providers of communication traffic excess via the server communication unit when determining that the total communication traffic of any of the plurality of groups exceeds the set upper limit value.

4. The management server according to claim 3, wherein
the communication traffic management unit is configured to request a selected in-vehicle device among the plurality of in-vehicle devices to restrict communication via the server communication unit, and
the selected in-vehicle device installs a group determined to have the total communication traffic exceeding the set upper limit value among the plurality of groups.

5. A vehicle network system comprising:
a plurality of in-vehicle devices respectively mounted on a plurality of different vehicles; and
a management server,
wherein
each of the plurality of in-vehicle devices includes:
an in-vehicle communication unit configured to wirelessly communicate with the management server;
an application execution unit configured to install and execute a plurality of application programs, wherein each of the plurality of application programs has application identification data identifying each of the plurality of application programs; and
a communication traffic measurement unit configured to
measure a communication traffic according to execution of each of the plurality of application programs by the application execution unit for each application identification data, and
transmit, to the management server via the in-vehicle communication unit, communication information in which each measured communication traffic is associated with the application identification data, and
the management server includes:
a server communication unit configured to wirelessly communicate with the plurality of in-vehicle devices; and
a communication traffic management unit configured to
acquire communication information from the plurality of in-vehicle devices,
total the communication traffic for each application identification data, and
calculate an application communication traffic.

6. The vehicle network system according to claim 5, wherein
the server communication unit is configured to wirelessly communicate with a service server related to each of a plurality of service providers,
the plurality of application programs are divided into a plurality of groups,
each of the plurality of groups is provided by a different service provider among the plurality of service providers, and
the communication traffic management unit is configured to total a corresponding application communication traffic for each of the plurality of groups to calculate a total communication traffic for each of the plurality of groups.

7. The vehicle network system according to claim 6, wherein
the communication traffic management unit is configured to
determine whether the calculated total communication traffic exceeds a set upper limit value for each of the plurality of groups, and
notify a service server related to a corresponding service provider among the plurality of service providers of communication traffic excess via the server communication unit when determining that the total communication traffic of any of the plurality of groups exceeds the set upper limit value.

8. The vehicle network system according to claim 7, wherein
the communication traffic management unit is configured to request a selected in-vehicle device among the plurality of in-vehicle devices to restrict communication via the server communication unit, and
the selected in-vehicle device installs a group determined to have the total communication traffic exceeding the set upper limit value among the plurality of groups.

9. The vehicle network system according to claim 8, wherein
the in-vehicle communication unit is configured to provide notification to the application execution unit upon receiving a communication restriction request.

10. The vehicle network system according to claim 8, wherein
upon receiving a communication restriction request, the in-vehicle communication unit is configured to restrict communication even when receiving a communication request from the application execution unit.

11. The vehicle network system according to claim 5, wherein
the communication traffic measurement unit is configured to
measure the communication traffic,
acquire a communication transmission destination, a communication type, and a vehicle state, and
add the communication transmission destination, the communication type, and the vehicle state to the communication information.

12. A communication traffic collection method comprising:
wirelessly communicating with a plurality of in-vehicle devices that are respectively mounted on a plurality of different vehicles, wherein each of the plurality of in-vehicle devices is configured to execute a plurality of application programs, and each of the plurality of application programs has application identification data for identifying each of the plurality of application programs;
acquiring a communication traffic according to execution of each of the plurality of application programs from each of the plurality of in-vehicle devices;
totaling the communication traffic for each application identification data; and
calculating an application communication traffic.

13. The management server according to claim 1, further comprising
a processor that serves as the server communication unit and the communication traffic management unit.

14. The vehicle network system according to claim 5, wherein:
each of the plurality of in-vehicle devices further includes a first processor that serves as the in-vehicle communication unit, the application execution unit, and the communication traffic measurement unit, and
the management server further includes a second processor that server as the server communication unit and the communication traffic management unit.
